(19) United States
(12) Patent Application Publication
(10) Pub. No.: US 2008/0100833 A1
(43) Pub. Date: May 1, 2008

(54) LASER CALIBRATION

(75) Inventors: Lawrence N. Taugher, Loveland, CO (US); Andrew L. Van Brocklin, Corvallis, OR (US); Neel Banerjee, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/552,523

(22) Filed: Oct. 25, 2006

(51) Int. Cl. G01J 1/10

(52) U.S. Cl. 356/243.1

(57) ABSTRACT

Various methods and systems for laser calibration are disclosed.

### BACKGROUND

Lasers are sometimes used to write labels upon a disc storage medium. Improperly calibrated lasers may result in poor quality labels. Systems for calibrating lasers are often expensive and use a large and sometimes visibly apparent calibration swatch or region.

### BRIEF DESCRIPTION OF THE DRAWINGS

FIG. 1 is a schematic illustration of one embodiment of a laser writing and calibration system according to an example embodiment.

FIG. 2 is a schematic sectional view of a disc having calibration regions formed thereon according to an example embodiment.

FIG. 3 is a top plan view of another disc including calibration regions and a sensed area including calibration regions and non-calibration regions according to an example embodiment.

FIG. 4 is a side elevational view schematically illustrating a sensing system sensing calibration regions on the disc of FIG. 3 according to an example embodiment.

FIG. 5 is a sectional view taken a long line 5-5 of FIG. 4 according to an example embodiment.

FIG. 6 is a top plan view of another disc including calibration regions and a sensed area including calibration regions and non-calibration regions according to an example embodiment.

FIG. 7 is a side elevational view schematically illustrating another embodiment of the sensing system of FIG. 4 sensing calibration regions on the disc of FIG. 6 according to an example embodiment.

FIG. 8 is a sectional view taken along 8-8 of FIG. 7 according to an example embodiment.

### DETAILED DESCRIPTION OF THE EXAMPLE EMBODIMENTS

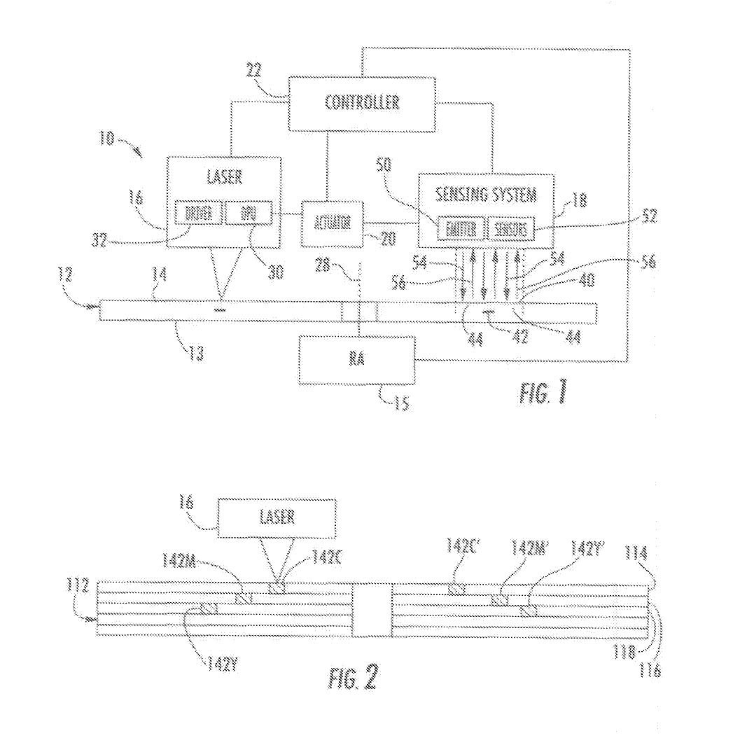

FIG. 1 schematically illustrates one example of the laser writing and calibration system 10 according to an example embodiment. System 10 is configured to calibrate a laser for writing visible labels upon a storage medium such as disc 12. Disc 12 comprises a disc configured to store data and to be written upon with a laser to provide the disc with a visible label. For purposes on this disclosure, the term “label” shall mean any image, graphic, photo, drawing, picture, alphanumeric symbols, design and the like that are visible to a human eye. Such labeling may directly communicate information regarding the content or characteristic of the data on disc 12 to a person. Such labeling may also alternatively visually communicate other information to a person.

In one embodiment, disc 12 comprises an optical disc. Disc 12 includes both data storage portions and label portions. In one embodiment, data storage portions are located on a first side 13 of disc 12 and label portions are located on a second opposite side 14 of disc 12. For purposes of this disclosure, when discussing the disc, the term “side” refers to the general side from which the data or label may be read or otherwise accessed and not the relative positioning of a layer of material or the positioning of the data or label with respect to a plane bisecting a thickness of the disc. For example, in some embodiments, label markings on disc 12 may be viewed or accessed from side 14 of disc 12 while being physically closer to side 13.

Examples of disc 12 include, but are not limited to, writeable and rewriteable compact discs (CD+/-R, CD+/-RW), writeable and rewriteable digital versatile discs (DVD+/-R, DVD+/-RW), Blu-Ray discs and the like. Label portions of disc 12 include one of more layers of one more materials configured to change between a light translucent state and a darkened light-absorbing or light-attenuating state in response to being irradiated by energy such as from a laser. One example of such a material includes BK-400 or Black 400 commercially available from Nagase America Corporation, New York, N.Y. In other embodiments, disc 12 may alternatively include other materials.

System 10 generally includes rotary actuator 15, laser system (laser) 16, sensing system 18, actuator 20 and controller 22. Rotary actuator 15 comprises a device configured to rotatably drive disc 12 about axis 28. In one embodiment, rotary actuator 15 comprises a motor having a spindle which is rotated to rotate disc 12. Rotary actuator 15 rotates disc 12 in response to control signals from controller 22.

Laser 16 comprises a device configured to direct a laser at disc 12, wherein the laser has a sufficient power or intensity so as to modify one or more inks or other label materials of disc 12 to form a label along disc 12. In one embodiment, laser 16 includes an optical pickup unit 30 and a laser drive 32. Optical pickup unit 30 generates and directs coherent light, such as a laser, in response to modulated voltage received form laser driver 32. Optical pickup unit 30 includes a source of coherent light, such as a laser diode, and optics including an objective lens configured to focus the light on disc 12. In particular embodiments, optical pickup unit 30 may additionally include a sensor, such as a photo detector, configured to sense and translate light reflected from disc 12 into machine-readable data for reading binary data written on disc 12. Laser drive 32 comprises an integrated circuit configured to provide optical pickup unit 30 with modulated electrical current which drives the source of coherent light.

Sensing system 18 comprises a system configured to sense one or more colors of light reflected from disc 12. In particular, sensing system 18 comprises a device configured to concurrently or near concurrently sense light reflected from an area 40 of disc 12 which includes one or more calibration regions 42 and surrounding or adjacent non-calibration regions 44. Sensing system 18 provides signals to controller 22 enabling controller 22 to distinguish sensed values resulting from light reflected off calibration regions 42 from sensed values resulting from light reflected off non-calibration regions 44. Because sensing system 18 provides signals enabling controller 22 to distinguish between sensed values taken from calibration region 42 versus sensed values taken from non-calibration region 44, calibration regions 42 may be reduced in size, reducing their visual noticeability, while maintaining or insubstantially reducing the sensing reliability of sensing system 18.

In the particular example illustrated, sensing system 18 includes emitter 50 and sensor 52. Emitter 50 comprises a device configured to emit or direct visible light (schematically illustrated by arrows 54) at area 40 of disc 12. Sensor 52 comprise an array of sensors or sensor elements configured to sense light reflected from disc 12 (schematically illustrated by arrows 56) from across area 40. In other words, elements of sensor 52 sense light reflected from both calibration region 42 and non-calibration region 44. In one embodiment, emitter 50 is configured to emit different colors of light at different times. In other embodiments, emitter 50 provides a combination of multiple colors of light, such as white light, during sensing, wherein sensor 52 includes multiple arrays, each array receiving a different filtered color of light.

Actuator 20 comprises one or more devices configured to selectively position optical pickup unit 30 of laser 16 and sensing system 18 relative to disc 12. In one embodiment, optical pickup unit 30 and sensing system 18 may be supported by a common structure, such as a sled, which radially moves with respect to disc 12. In such an embodiment actuator 20 may include a DC or stepper motor operably connected to the sled or other structure so as to move the sled or other structure. In particular embodiments, actuator 20 may additionally include a servo which includes a first actuator configured to move the objective lens of the optical pickup unit 30 in a direction generally perpendicular to the face of disc 12 to adjust a focus of the laser generated by optical pickup unit 30 and a second actuator (not shown) configured to move the objective lens of optical pickup unit 30 and sensing system 18 in a direction radially with respect to the face of disc 12 to more precisely adjust positioning of the laser generated by optical pickup unit 30 or the location of area 40 being sensed by sensing system 18. In one embodiment, the first and second actuators may comprise motors. In particular embodiments, the first and second actuators may comprise voice coils. In other embodiments, other actuators may be used. In still other embodiments, optical pickup unit 30 of laser 16 and sensing system 18 may alternatively be moved relative to disc 12 using distinct actuators.

Controller 22 comprises one or more processing units configured to generate control signals for directing the operation of rotary actuator 15, laser 16, sensing system 18 and actuator 20. In the example illustrated, controller 22 analyzes signals or information received from sensing system 18 to calibrate or adjust laser 16. For purposes of this disclosure, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 22 is not limited to any specific combination of hardware circuitry and software, nor to any particular source for the instructions executed by the processing unit.

To calibrate laser 16 for writing labels upon disc 12, controller 22 generates control signals directing laser 16 to form calibration regions 42 upon disc 12. In particular, controller 22 generates control signals directing rotary actuator 15 and actuator 20 to appropriately position optical pickup unit 30 of laser 16 with respect to the disc 12. At multiple selected positions along disc 12, controller 22 generates control signals directing optical pickup unit 30 to apply a laser to the ink or label writing material of disc 12. At each of the positions, controller 22 generates control signals directing optical pickup unit 30 to apply a laser at a different power level. This may result in different calibration regions 42 having different optical properties such as having different optical reflective or absorbing properties. For example, the application of a laser having a first power level to a first calibration region 42 may result in the first calibration region 42 reflecting a color, such as magenta, to a first shade or degree, such as a light magenta. The application of a laser having a second power level to a second calibration region 42 may result in the second calibration region 42 reflecting the same color, such as magenta, to a second shade or degree, such as a darker magenta. As will be described hereafter, sensing system 18 senses the different shades or degrees, wherein controller 22 uses the values to calibrate the power applied by laser 16 to form a desired degree or shade of the color when subsequently writing a label.

Once multiple calibration regions 42 formed at different levels of laser power have been formed upon disc 12, controller 22 generates control signals directing actuator 20 to appropriately position sensing system 18 relative to at least one of the calibration regions 42. In particular, controller 22 generates control signals directing actuator 20 to position sensing system 18 such that emitter 50 directs light across an area 40 encompassing both the one or more calibration regions 42 and the surrounding non-calibration regions 44. The non-calibration regions 44 have a color or shade of color distinct from that of calibration region 42. In one embodiment, the non-calibration regions 44 have a white or near white color. The light provided by emitter 50 (schematically illustrated by arrows 54) is reflected off of both calibration regions 42 and non-calibration regions 44 (as schematically illustrated by arrows 56). Elements of sensor 52 detect the reflected light. Because sensor 52 comprises an array of sensors or sensor elements, a first portion of sensor elements detect light reflected from calibration region or regions 42 while a second portion of sensors detect light reflected from non-calibration regions 44. Signals from the first portion of sensor elements and the second portion of sensor elements are transmitted to controller 22.

Controller 22 receives signals or sensed values from both the first portion of elements of sensor 52 and a second portion of the elements of sensor 52. By comparing such values, controller 22 identifies the portion of the array of sensors that has sensed calibration region 42 or identifies the sensed values taken from the one or more calibration regions 42 in area 40. For example, in one embodiment, the one or more calibration regions 42 may constitute a very small percentage of area 40. As a result, the number of individual sensors or sensor elements sensing light reflected from non-calibration regions 44 will be larger than the number of individual sensors or sensor elements sensing light reflected from the one more calibration regions 42. Controller 22 may identify those particular sensors that have sensed light reflected from the one or more calibration regions 42 by identifying those sensors or sensor elements providing similar sensed values which are in a minority so compared to the number of sensors or sensor elements providing one or more other common sensed values. In still another embodiment, controller 22 may identify the particular sensor elements which have sensed light reflected from the one or more calibration regions 42 or the sensed values taken from the one or more calibration regions 42 by separating or filtering out those sensed values which are substantially similar to previously determined or known values of light reflected from non-calibration region 44.

Once controller 22 has identified the portion or particular sensors of the array of sensor 52 that have sensed light reflected from the one or more calibration regions 42 in area 40, controller 22 uses the sensed values from the identified portion of sensor 52 to adjust or calibrate the level of power of the laser applied to disc 12 to form a desired label marking on disc 12 having a desired color. For example, if a particular label is to use a mark having a light magenta color, controller 22 may generate control signals directing laser 16 to have the first power level. If a particular label is to use a mark having a dark magenta color, controller 22 may generate control signals directing laser 16 to have the second level of power when forming the mark. Using the sensed values, controller 22 may also determine other levels of power between the first two levels of power or outside of the first two levels of power to form marks in a label having other shades of the color.

In some applications, disc 12 may include one or more inks configured to reflect different colors such that disc 12 may be provided with a multicolor label. For example, in one embodiment, disc 12 may be configured to be written upon by laser 16 so as to absorb selected wavelengths of light to provide cyan, magenta and yellow colors, wherein half-toning may be used to provide disc 12 with colors across a broad color spectrum. FIG. 2 schematically illustrates the forming of calibration regions for multiple colors on a disc 112 by laser 16. Disc 112 is similar to disc 12 except that disc 12 includes layers 114, 116, 118 of ink or other label writing material. Layers 114, 116 and 118 each include a different ink formulation which upon being irradiated by laser 16 reflect a different colors of light. For example, in one embodiment, those portions of layer 114 which are irradiated by a laser reflect cyan colored light. Those portions of layer 116 which are irradiated by laser 16 reflect a magenta colored light. Those portions of layer 118 that are irradiated by a laser reflect a yellow colored light. In other embodiments, layers 114, 116 and 118 may be configured to reflect other colors of light upon being irradiated. Layer 16 selectively irradiates layers 114, 116 and 118 by irradiating disc 112 with laser beams having different wavelengths. FIG. 2 schematically illustrates laser 16, in response to control signals from controller 22 (shown in FIG. 1), irradiating a portion of layer 114 with a laser having a first wavelength at a first power level to form a first calibration region 142C for the color cyan provided by layer 114. FIG. 2 further illustrates previously formed calibration regions 142M and 142Y formed in layers 116 and 118 for the colors magenta and yellow provided by such layers, respectively.

FIG. 2 further schematically illustrates irradiation of a second portion of layer 114 with a laser having the same wavelength as that forming region 142C but to with a second power level to form a second calibration region 142C′ in layer 114. FIG. 2 also illustrates the previously formed calibration regions 142M′ and 142Y′ in layers 116 and 118 which were formed by applying a laser having substantially the same wavelength but a different power level as that of the lasers applied to form regions 14sM and 142Y, respectively.

In such an embodiment, controller 22 uses sensing system 18 to sense the shade of color reflected by regions 142C and 142C′ to determine an appropriate power level for laser 16 when laser 16 is subsequently forming cyan colored pixels or areas of a label in layer 114 on disc 112. The chosen power level may then be used to calibrate the power settings of laser 16. In a similar manner, controller 22 senses light reflected from calibration regions 142M and 142M′ to determine an appropriate laser power level to achieve a desired shade or intensity of the magenta colored light reflected by those portions of layer 116 that have been irradiated. Based upon sensed light reflected from calibration regions 142Y and 142Y′, controller 22 determines an appropriate power level for laser 16 when laser 16 is subsequently forming yellow colored pixels or areas of a label in layer 118 on disc 112.

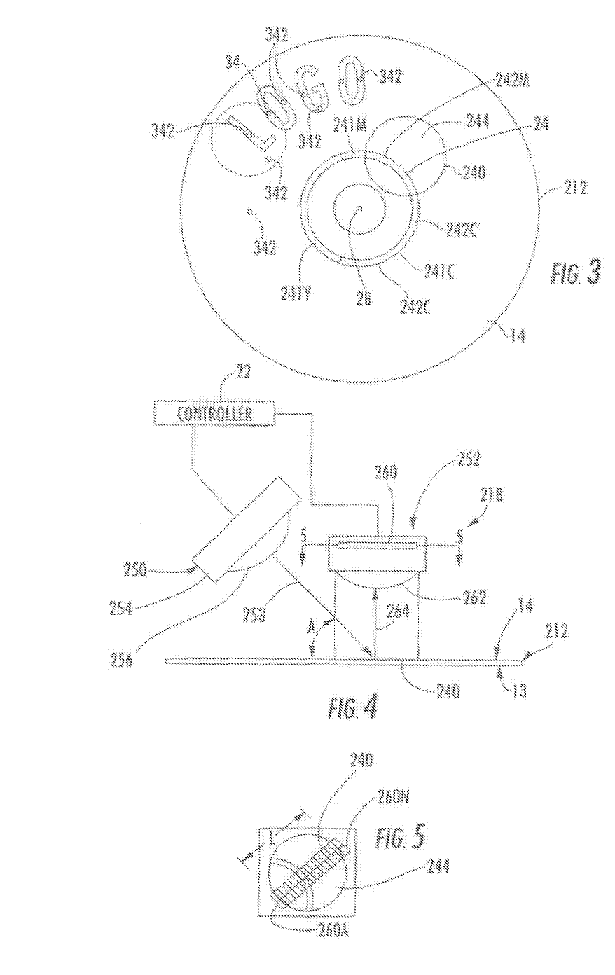

FIG. 3 schematically illustrates various methods for forming calibrations regions on a disc, such as disc 212. Disc 212 has a data side 13 (shown in FIG. 4) and an opposite label side 14 as described above with respect to disc 12. As shown in FIG. 3, as part of one example process for calibrating laser 16 (shown in FIG. 1), controller 22 (shown in FIG. 1) generates control signals directing laser 16 to irradiate label side 14 of disc to 12 to form calibration segments 241C, 241M and 241Y (collectively referred to as calibration segments 241). Calibration segments 241 circumferentially extend around or about a rotational axis 28 of disc 212. Each of calibration segments 241 is associated with a particular labeling color. In the example illustrated, segment 241C is associated with cyan, segment 241M is associated with magenta and segment 241Y is associated with yellow. In other embodiments segments 242 may be associated with other colors. In one embodiment, similar to disc 112 described with respect to FIG. 2, disc 212 may include layers of distinct inks or label writing material which upon being irradiated with a laser of an appropriate wavelength change to reflect particular colors of light. Each of segments 241C, 241M and 241Y includes multiple calibration regions 242 formed at different laser power levels. For example, calibration segment 241C may include a first calibration region 242C formed by irradiating disc 212 a first power level and a second calibration region 242C′ formed by irradiating disc 212 at a second power level. In the particular example illustrated, calibration regions 242 of each segment 241 continuously extend from end-to-end of each segment. As a result, calibration regions 242 of each segment having a greater density.

In lieu of being formed as part of a ring about axis 28, calibration marks may alternatively be formed in other manners. For example, as shown in FIG. 3, controller 22 (shown in FIG. 1) may alternatively generate control signals directing laser 16 (shown in FIG. 1) to form calibration regions 342 which are spaced from one another. Such regions 342 may be circumferentially located about axis 28 such that sensing system 218 may sense both regions 342 during a single rotation of disc 212. Alternatively, regions 342 may be radially spaced from one another. In other embodiments, calibration regions 342 may be spaced from one another while other regions 342 may be connected to one another so as to form a continuous linear or nonlinear segment.

Calibration regions may also be formed as part of a much larger graphic or alphanumeric symbol (other than a circumferential ring) on label side 14 of disc 212. For example, as shown in FIG. 3, controller 22 (shown in FIG. 1) may generate control signals directing laser 16 (shown in FIG. 1) to from calibration regions 342 which are embedded in or with other label writing marks or regions on disc 212 which collectively form a graphic or alphanumeric symbol. In the example illustrated, calibration regions 342 are embedded with other label markings which collectively form the word “LOGO”. In such an embodiment, calibration region 342 may be spaced from one another within individual alphanumeric symbols or graphics or may abut one another as part of individual alphanumeric symbols or graphics. As a result, even though such calibration regions 342 may be larger, such calibration regions may be visually indiscernible as calibration regions.

FIG. 4 schematically illustrates sensing system 218, another embodiment of sensing system 18 of the system 10 shown in FIG. 1. FIGS. 3-5 further illustrate interaction between sensing system 218 and disc 212. As shown by FIG. 4, sensing system 218 includes emitter 250 and sensor 252 which are operably controlled by controller 22 (described above with respect to system 10). Emitter 250 comprises a device configured to emit and direct different colors of visible light (schematically illustrated by arrow 253) across and area 240 of disc 212 which includes one or more calibration regions 242 and non-calibration regions 244. Emitter 250 generally includes light emitting elements 254 and optics 256.

Light emitting elements 254 comprise elements configured to emit a distinct color of light and to be selectively actuated. In one embodiment, emitter elements 254 comprises a group of light emitting diodes, wherein the diodes themselves emit particular colors of light. In other embodiments, the emitter elements may comprise diodes or other light sources configured to emit white light and color filters positioned or arranged to filter the white light before the light impinges area 240. According to one embodiment, the individual light emitting elements 254 emit different colors dispersed across the color spectrum. For example, in one embodiment, emitter 250 includes one or more elements 254 configure to emit red light, one or more elements 254 configured to emit green light and one or more elements 254 configured to emit blue light. In yet other embodiments, emitter 250 may include elements 254 configured to emit 16 different colors of light across the color spectrum. In yet other embodiments, emitter 250 may include elements 254 configured to emit different color combinations or greater or fewer colors of the color spectrum.

Optics 256 comprises one or more optical components configured to direct and focus light form emitters 251 on to area 240. In particular embodiments where elements 254 are sufficiently focused, optics 256 may be omitted. Although emitter 250 is illustrated as impinging area 240 at an angle A of about 45 degrees, in other embodiments, angle A may have other angles. In other embodiments, emitter 250 may be supported with sensor 252.

Sensor 252 comprises an array of sensor elements 260A-260N (collectively referred to as sensor elements 260). In one embodiment, sensor elements 260 are arranged end-to-and or side-by-side so as to abut one another such that sensor elements 260 provide a collective sensing length L spanning area 240. In one embodiment, sensing length L is at least about 10 um and nominally about 100 um. In a particular example illustrated, sensor elements 260 are arranged in an array which extends in a radial direction with respect to axis 28 of disc 212. As a result, one or more of sensor elements 260 is more likely to be aligned opposite to calibration regions 242 during rotation of disc 212.

In the particular example illustrated, the array of sensor elements 260 is arranged in two radially extending rows. As a result, at least one of the two rows is more likely to have sufficient time for sensing the color of a calibration region 242 passing opposite to sensor elements 260. In other embodiments, sensor elements 260 may be arranged in other orientations with respect to disc 212 and may be arranged in greater than or fewer than two rows. In one embodiment, each sensor element 260 has dimensions less than or equal to about 1 mm×1 mm and nominally about 100 um×100 um. In one embodiment, sensor elements 260 comprise a S7805-10 photodiode with integrated amplifier commercially available from Hamamatsu. In other embodiments, other sensor elements 260 may be utilized.

As further shown by FIG. 4, in particular embodiments, sensor 252 may additionally include optics 262 configured to image the desired field of view on area 240. Therefore capturing light reflected from area 240 (schematically illustrated by arrow 264) onto sensor elements 252. In other embodiments, other optics 262 may be used.

In operation, controller 22 generates control signals directing emitter 250 to selectively actuate emitter elements 252 to emit different colors or wavelengths of light (represented by arrow 253) at different times at area 240 on disc 212. Light from emitter elements 254 impinges area 240 of disc 212 and is partially absorbed and partially reflected as indicated by arrow 264. The reflected light from one or more calibration regions 242 and non-calibration region 244 impinges sensor elements 260. Sensor elements 260 sense the reflected light and transmit signals or sensed values to controller 22. Controller 22 either identifies which particular sensor elements 260 are transmitting values based upon light reflected from the one or more calibration regions 242 or identifies those particular sensed values received which are based upon light reflected from the one or more calibration regions 242 as described above in more detail with respect to system 10 in FIG. 1. Controller 22 uses the sensed values taken from the one or more calibration regions 242 to calibrate, adjust or select power levels for laser 16 when subsequently forming labels upon label side 14 of disc 212. Sensed values from non-calibration regions 244 are either discarded or are stored for later use by controller 22 in distinguishing sensed values taken from calibration regions 242 versus non-calibration regions 244.

Because systems 218 utilizes individual sensor elements 260 arranged in an array which spans or substantially spans area 240, calibration regions 242 may be reduced in size without substantially decreasing the ability of sensor elements 260 to be appropriately aligned across the one or more calibration regions 242 during rotation of disc 212. Because calibration regions 242 may be made smaller, calibration regions 242 are less visually discernible and a greater area of label side 14 may be subsequently used for labeling rather than label power calibration.

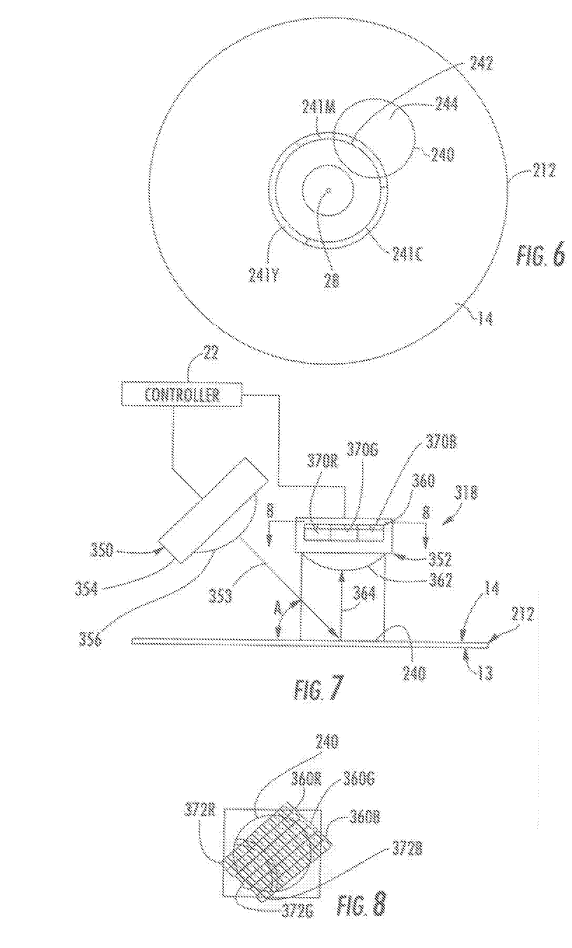

FIGS. 6-8 schematically illustrate sensing system 318, another embodiment of sensing system 18, and the interaction of sensing system 318 with disc 212. As shown by FIG. 7, sensing system 318 generally includes emitter 350 and sensor 352. Emitter 350 is similar to emitter 250 except that emitter 350 concurrently emits multiple colors or wavelengths of light, such as substantially white light, at area 240 of disc 212 (as schematically illustrated by arrow 353) during calibration of each of calibration regions 242. In one embodiment, emitter 350 includes one or more emitter elements 354 which emit the same color of light or which concurrently emit different colors of light at area 240. In one embodiment, emitter 350 may additionally include optics 356 for focusing and/or homogenizing light from elements 354. In one embodiment, emitter elements 354 may comprise one or more light emitting diodes. In other embodiments, other sources of light may be utilized.

Sensor 352 comprise a device configured to concurrently sense color components of light reflected from across substantially all of area 240 (as schematically illustrated by arrow 364). Sensor 350 include sensor elements 360R, 360G and 360B (collectively referred to as sensor elements 360, filter elements 370R, 370G and 370B, and optics 362. Sensor elements 360 are each individually similar to sensor elements 260 described above with respect to system 218. Sensor elements 360R, 360G and 360B are substantially similar to one another except that sensor elements 360R, 360Gk and 360B are associated with different color light filter elements 370R, 370G and 370B, respectively. In the particular example illustrated, sensor elements 360R are arranged in a first array 372R, sensor elements 360G are arranged in a second array 372G and sensor elements 360B are arranged in a third array 372B (collectively referred to as arrays 372). Each of arrays 372R, 372G and 372B to substantial similar to the array of sensor elements 260. As with the array of sensor elements 260 in FIG. 5, each of arrays 372 has a collective sensing length substantially equal to or greater than a corresponding dimensions area 240. As shown by FIG. 8, arrays 372 each generally extend in a radial direction with respect to the rotational axis 28 of disc 212. Arrays 372 are generally arranged side-by-side so-as to abut one another. In other embodiments, arrays 372 may be spaced from one another radially or circumferentially. Although each array 372 is illustrated as including two rows of sensor elements 360, in other embodiments, each array 372 may include greater or fewer than two rows.

Filter elements 370 comprise structures configured to filter wavelengths of visible light, permitting one or more designated wavelengths or ranges of wavelengths to pass therethrough. Filter elements 370 are located so as to intercept reflected light (schematically represented by arrow 364) before such light reaches sensor elements 360. As a result, sensor elements 360 sense particular color components of light 364.

In the example illustrated, filter element 370R is configured to filter light except red light. Filter element of 370G is configured to filter light except for green length. Filter element 370B is configured to filter light except for blue light. As a result, sensor elements 360R, 360G and 360B sense red, green and blue light components of light 364, respectively. In other embodiments, sensor 352 may be provided with additional color filter elements positioned opposite additional sensor arrays 372 to facilitate sensing of a greater number of color components across the color spectrum by sensor 352.

In operation, controller 22 generates control signals directing emitter 350 to concurrently emit multiple colors of light including colors corresponding to filter elements 370. In one embodiment, emitter 350 emits a combination of red, green and blue light, i.e. white light. Optics 356 focuses the white lights on area 240. Light 364 reflects off of calibration regions 242 on disc 212 and off of non-calibration regions 244 of disc 212 in areas 240. Optics 362 focuses reflected light 364 through filter elements 370 and onto sensor elements 360. Sensor elements 360R sense a red component of the light reflected from the particular calibration region 242. Sensor elements 360G sense a green component of the light reflected from the particular calibration region 242. Sensor elements 360B sense a blue component of the light reflected from the particular calibration region 242. Such signals are transmitted to controller 22 which combines the sensed signals to determine the color of the particular calibration region 242. Controller 22 performs substantially the same steps for other calibration regions 242 of the same color but formed at different laser power levels to determine an appropriate laser power level for a particular color. Controller 22 performs substantially the same steps for each of the label colors. In the example illustrated, controller 22 performs the same steps for multiple calibration regions for each of the label colors cyan, magenta and yellow. Because system 318 concurrently senses multiple color components of light reflected from each calibration regions 242, system 318 may complete color sensing and laser power calibration or selection more quickly with fewer revolutions of disc 212.

Although the present disclosure has been described with reference to example embodiments, workers skilled in the art will recognize that changes may be made in form and detail without departing from the spirit and scope of the claimed subject matter. For example, although different examples embodiments may have been described as including one or more features providing one more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompasses a plurality of such particular elements.

What is claimed is:

1. A method comprising:
(a) sensing, by a first array of sensors, light reflected from a first area of a disc, where the first area includes a calibration region and a non-calibration region;
(b) identifying a portion of the first array that is sensing light reflected from the calibration region of the first area; and
(c) calibrating a laser based upon sensed values produced by the portion of the first array identified at step (b).

2. The method of claim 1, wherein the first area calibration region and the first area non-calibration region have at least one different optical property that permits step (b) to be performed.

3. The method of claim 1, wherein the first area calibration region and the first area non-calibration region are one of a different color or a different shade of a same color.

4. The method of claim 2, further comprising impinging the first area with different wavelengths of light at distinct times.

5. The method of claim 4, wherein the different wavelengths of light impinging on the first area correspond to at least 3 colors.

6. The method of claim 4, wherein the different wavelengths of light impinging the first area correspond to at least 16 colors.

7. The method of claim 1, further comprising filtering the light reflected from the first area prior to sensing the light with the first array of sensors.

8. The method of claim 1, further comprising:
filtering the light reflected from the first area with a first color filter prior to sensing the light with the first array of sensors;
filtering the light reflected the first area with a second color filter;
sensing, by a second array of sensors, the light filtered by the second color filter;
identifying a portion of the second array that has sensed the first area calibration region, wherein calibrating the laser is additionally based upon sensed values from the identified portion of the second array.

9. The method of claim 1, further comprising:
(e) sensing, by the array of sensors, light reflected from a second area of the disc, where the second area includes a calibration region and a non-calibration region;
(f) identifying a portion of the array that is sensing light reflected from the second area calibration region,
wherein the laser is calibrated additionally based upon sensed values produced by the portion of the array identified at step (f).

10. The method of claim 9, further comprising:
irradiating the disc with a laser at a first power to form the first area calibration region; and
irradiating the disc with the laser at a second power to form the second area calibration region.

11. The method of claim 9, wherein the first area calibration region reflects one of cyan, yellow and magenta colors of light and wherein the second area calibration region reflects a second one of the cyan, yellow and magenta colors of light.

12. The method of claim 9, wherein the first area calibration region reflects one of cyan, yellow and magenta colors of light to a first degree and wherein the second area calibration region reflects said one of cyan, yellow and magenta light to a second distinct degree.

13. The method of claim 9, wherein the first area calibration region and the second area calibration region are circumferentially located with respect to one another about a rotational axis of the disc.

14. The method of claim 9, wherein the first area calibration region and the second area calibration region are formed as part of an alpha-numeric symbol or graphic along the disc.

15. A method comprising:
irradiating a disc with a laser at a first power to form a first calibration region;
irradiating the disc with the laser at a second power to form a second calibration region, wherein the first calibration and the second calibration region form an alphanumeric symbol or graphic on the disc;
sensing the first calibration region and the second calibration region; and
calibrating a power of the laser based upon sensed values from the first calibration region and the second calibration region.

16. The method of claim 15 wherein sensing the first calibration region comprises:
sensing light reflected from a first area of the disc including the first calibration region with an array of sensors;
identifying a portion of the array that has sensed the first calibration region; and
calibrating the power of the laser using sensed values from the identified portion of the array.

17. A system comprising:
a first array of sensors; and
a controller configured to generate control signals directing the first array of sensors to sense light reflected from a first area of a disc including a first calibration region, to identify a portion of the array that has sensed the first calibration region and to calibrate a laser based upon values sensed from the identified portion of the first array.

18. The system of claim 17 further comprising an emitter configured to emit different colors of light at the first area of the disc at distinct times.

19. The system of claim 17 further comprising a first color filter configured to filter light reflected from the first area of the disc.

20. The system of claim 17 further comprising:
a second array of sensors configured to sense light reflected from the first area of the disc including the first calibration region;
a second color filter configured to filter light reflected from the first area;
a third array of sensors configured to sense light reflected from the first area of the disc including the first calibration region;
a third color filter configured to filter light reflected from the first area, wherein the controller is additionally configured to identify a portion of the second array of sensors and a portion of the third array of sensors that has sensed the first calibration region and wherein the controller is configured to calibrate the laser additionally based upon values sensed by the identified portion of the second array and the identified portion of the third array.
